(19) United States
(12) Patent Application Publication
(10) Pub. No.: US 2004/0099011 A1
(43) Pub. Date: May 27, 2004

(54) Nitrogen oxide reduced introduction of fuel in combustion air ports of a glass furnace

(76) Inventors: Frank Hegewald, Cottbus (DE); Peter Hemmann, Freiberg (DE); Helmut Heelemann, Kiekebusch (DE)

Correspondence Address: HAHN LOESER & PARKS, LLP, TWIN OAKS ESTATE, 1225 W. MARKET STREET, AKRON, OH, 44313, US

(21) Appl. No.: 10/312,612

(22) PCT Filed: Jul. 5, 2001
(86) PCT No.: PCT/EP01/07711

(30) Foreign Application Priority Data
Jul. 5, 2000 (DE) 100 44 237.4
Apr. 25, 2001 (DE) 101 20 371.3

(51) Int. Cl. C03B 5/235

(52) U.S. Cl. 65/136.3; 65/336; 65/346

(57) ABSTRACT

The invention concerns NOx-reduced firing of glass melting furnaces with preferably lateral fuel introduction at the combustion air ports thereof, wherein cross-flows of combustion air and combustible gas are suppressed by means of wall segments arranged in the combustion air port, air turbulence at the wall segment is reduced by waste gas filling of reduced-pressure regions and a primarily low-turbulence flame base is produced, which is based on the introduction of combustible gas in the form of a free jet. The wall segment and the waste gas filling jointly form a so-called flame base screen. As a secondary aspect the free jet is protected by the combustible gas jet being introduced into the core shadow of the flame base screen. The wall segment preferably simulates the idealised projection of a free gas jet, from the direction of view of the afflux flow of combustion air. Exhaust gas filling of the turbulence space is effected by the introduction of waste gas and/or fuel, preferably by means of a displacement lance, and upstream of the wall segment it forms a gas-dynamic waste gas spoiler which lifts the afflux flow of combustion air over the wall segment with a turbulence-reducing effect. Preferably the displacement lance has at least one axial gas discharge slot, it is disposed horizontally on the air afflux flow side at the foot of the wall segment and can be positioned axially and radially in relation to the wall segment.

The invention concerns a so-called primary measure for NOx-reduction, in particular processes and associated apparatuses for NOx-reduction on flames of fossil-heated glass melting furnaces.

In this respect the term primary measures is used for the sake of simplicity and in the narrower sense as meaning those measures which are applied within the furnace to reduce the production of NOx. Considered even more narrowly the invention concerns firing management measures for NOx-reduction.

In comparison with secondary measures primary measures usually involve a lower level of complication and expenditure. It will be noted however that primary measures often do not achieve the desired reduction potential. Cross-flame glass melting furnaces with a lateral burner arrangement are particularly problematical as they have a very high initial level in respect of NOx and the known primary measures have little effect. For example when using NOx-reducing burners which have a high level of effectiveness in uses with underport-fired furnaces no effect worth mentioning is achieved on such furnaces.

The suppression of NOx-formation is essentially based on the consideration, in regard to thermal NOx, that the combustion of nitrogen and oxygen in the air to form NOx, which occurs at high temperatures, is reduced. What is essential in terms of the substances involved in that respect is the local concentration product of oxygen and nitrogen, with which the NOx-formation rises. In thermal terms it is the temperature of the flame that is essential, in particular at the base of the flame. Starting points in regard to NOx-reduction in relation to the first aspect are the air pre-heating temperature of the combustion air, the cold ‘secondary air’, the (local) fuel-air ratio, as well as the composition of the air, that is to say the waste gas, N₂ and O₂ content thereof. In that respect a series of processes have been developed, such as for example the oxyfuel process which involves the replacement of combustion air by virtually pure oxygen, or the near-stoichiometric mode of furnace operation, inter alia as disclosed in WO 98/02386 in which all excess air is avoided.

Further measures are technical changes to the furnace such as the arrangement of sealing plates at blowing nozzle blocks for the avoidance of injector air from the ambient atmosphere, or providing for sealing integrity in relation to infiltrated air ingresses on the furnace. An ‘air stepping process’ in accordance with DE 43 01 664 A1 avoids locally high concentration products at the critical flame base.

Modifications to burners or new burner types are also used for the purposes of NOx-reduction.

Waste gas recycling also reduces the local concentration product of nitrogen and oxygen, at the same time in that case, as also in other processes, the second reduction aspect is utilised and firing ignition is braked, which has a temperature-reducing influence. For example flameless oxidation in the burner is intended to avoid NOx and only the waste gas is to provide for heat transmission.

Those processes in which the mixing of fuel and air is delayed also seek to attain the aim of cooling the flame base. The ‘cascade firing procedure’ disclosed in DE 34 41 675 A1 and DE 44 15 902 C1 and carburisation steps are known for that purpose as ways of attaining that aim.

In general terms in that respect ignition of the flame or the main flame is delayed. Waste gas is added to the combustion air or introduced in a condition of enclosing the fuel jet. The flame base is cooled with water vapor. The geometrical configuration of introduction of the air into the furnace for low-turbulent air flow was known as a ‘free jet port’. That reduces turbulence in the air and premature random mixing of fuel and air. For heating oil, burners were known which avoid very fine drops upon atomisation of the oil. Hot flame bases are also avoided by gas burners which introduce the combustible gas into the furnace in a low-turbulence jet. Those burners are known as free jet burners.

Similar threshold member procedures are also known and have been used in the USA for energy-saving purposes for a relatively long time, see for example ‘Melting Furnace Design in the Glass Industry’, Alexis G Pincus, 1976. In this case also however the same problems arise. ‘Cascade firing’ differs from that approach in positive terms in that by virtue of the involvement of a small pre-flame, an O₂-depleted gas stream is implemented by way of the main burners arranged in an underbank firing configuration, whereby that risk is reduced in that situation.

Recently a further development in the cascade process involved using the arrangement of a threshold member in the port similarly to the above-mentioned process. This was known as ‘Second-generation cascade firing with integrated baffle wall technology’ (Glasingenieur May 1998). A disadvantage in this respect is that the waste gas layer to be formed by the cascade nozzle feed is initially itself produced by a flame and that flame itself becomes a strong emission source of NOx. The effectiveness in terms of the reduction action suffers from that. The process also cannot be used for furnaces with laterally fired ports.

The carburisation step process and second-generation cascade firing have the common aspect that combustible gas is introduced into the space of an air flow shadow of steps or threshold members, which is arranged at the step remote from the air afflux side. The step is characterised as a negative change in level of the port floor in the air flow direction. The difference between carburisation step and second-generation cascade is essentially that all the combustible gas or only proportions thereof are used downstream of that threshold/step.

Underbank firing with an increased spacing in respect of the introduction of fuel and the introduction of air is a measure for the man skilled in the art, which has arisen out of a comparison between various furnace structures. The number of flames is frequently reduced and thus the space of particularly hot or indeed adiabatic flame zones which are a main source of NOx is proportionally reduced.

The state of the art which is closest to the area with which the invention is concerned has been implemented for some years on a U-flame furnace for container glass. That solution essentially involves the arrangement of a carburisation step in the combustion air port, wherein the fuel is introduced into the flow shadow of the combustion air from both port side walls, each with a respective conventional gas burner, in such a way that the impulses of the two gas jets which are directed towards each other at least partially compensate each other. The decisive notion in terms of using that solution for the purposes of NOx-reduction was based on a calculation of the NOx-formation for that arrangement on the basis of the improvement, known from old publications and our own investigations, in the heat irradiation performance of the flames due to carburisation of combustible gases, with inherent and external carburisation, which was notified to the later user and the use thereof was thereafter recommended. In regard to risk assessment reference was made to the extremely modified flame image and soot formation. There were however no measurement results in respect of NOx-formation in that connection as carburisation steps have long been used prior to ecological revaluation of the NOx-problems exclusively for purposes relating to energy economy. In the following practical application of the process for NOx-reduction by a German glass furnace building corporation the calculation was also quantitatively confirmed in the meantime over several years. The operator identified the arrangement and process, in particular in respect of NOx-reduction, as being successful in comparison with the above-indicated state of the art. The problem of the formation of carbon deposits in the port is however not overcome and can easily become critical in other cases. That then requires non-productive compensation measures such as high air factors in terms of combustion. The nature of the flame shape and the position of the flames in the furnace space are almost exclusively dependent on the structural shape of the threshold member and the port. Burner setting actions involve excessively slight options of exerting an influence, both in the context of conventional target parameters and also in the context of innovative and technologically meaningful target parameters. The apparatus is less flexible, once implemented by the furnace structure. For example the process for inclined flame firing in accordance with DE 195 20 649 A1, which is effective for reducing NOx and increasing performance, cannot be transferred to installations which are set up in that way.

The problem which now arises is that many of the stated methods can only be used with a high level of expenditure, they are not suitable at all for certain furnace structures or they can only be used there to slight effect. As an example in this respect reference may be made to the frequently employed construction of a cross-flame furnace with a lateral burner arrangement at the combustion air port. In that arrangement combustion air and fuel are mixed directly after the fuel issues from the nozzle block in cross-flow relationship with each other. The consequence is a high level of NOx-formation. All the above-mentioned processes including the promising port step for gas carburisation do not resolve that fundamental problem or they have adverse side-effects. The carburisation step which is effective per se in respect of NOx-reduction requires a large structural height for a marked NOx-reduction, which as a side-effect causes an undesirably severe degree of throttling of the feed of combustion air. In addition, on cross-flame furnaces, if only a part of the ports provided are equipped in that way, waste gas and air are relatively greatly re-distributed to other ports. The structural change in the ports for taking account of those effects also have adverse side-effects as at least in a quite expensive fashion the structural size of the ports has to be increased.

However the use of the process for furnaces involving high quality demands is quite substantially restricted by virtue of the fact that the formation of elementary carbon, which is a compelling basis involved in the procedure with the carburisation step, cannot be reliably limited to fine distribution of the carbon particles but larger graphite deposits occur in the shadow of the step, which can also pass into the glass. That is a high potential danger in regard to glass production.

Therefore the object of the invention is to develop processes and apparatuses for effective nitrogen oxide-reduced combustible gas introduction in combustion air ports of glass melting furnaces, which substantially resolve the problems involved with the above-mentioned processes and apparatuses and which can be suitably and effectively used essentially for all furnace types, in particular also for the cross-flame furnace with lateral burner arrangement, which is critical in regard to NOx-reduction.

It was surprisingly found that the retrofitting of a combustion air port with a wall segment according to the invention which is combined with a gas-dynamic lifting effect according to the invention, as main components of flame base shielding, means that all side-effects of carburisation steps can be substantially avoided or suppressed and effective NOx-reduction can be achieved.

According to the invention that object is attained by the processes set forth in claims 1, 2 or 3 and associated apparatuses as set forth in claims 6, 15 and 20.

Preferably, introduced into the foot zone, which is exposed to an air afflux flow, of a flow barrier or a flow obstacle, is a gas jet in an amount which is between 1 and 5% of the fuel flow of the combustion air port in question.

An apparatus according to the invention concerns a protective apparatus in relation to the through-flow of combustion air in the immediate region of the introduction of fuel within a combustion air port of gas melting furnaces, in the form of what is known as a flame base screen, and is characterised by an air path-blocking wall segment which with the port floor and a port side wall forms a spatial angle closed on three sides. The wall segment according to the invention is of a length which is markedly shorter than half the width of the port floor, it is arranged substantially perpendicularly to the port side wall facing into the combustion air port, and its greatest height in relation to the lower directrix of the idealised combustible gas free jet is approximately equal to or greater than the sum of the diameter of the combustion gas intake and ⅓rd of the length of the wall segment. The wall segment is advantageously of a great wall thickness, wherein the wide masonry crown of the air path-blocking wall segment has a shallow rise of about 10° which is measured in the air flow direction with respect to the plane of the port floor.

In a further preferred embodiment the apex of the crown of the wall segment in the afflux flow direction of the combustion air simulates a vertically flat projection of a free gas jet. Preferably the apex, from the port side wall to the distal end thereof, has a continuous or stepped rise of about 20°.

In addition the perpendicular end face of the wall segment, which face is towards the center of the port, at least over the greater part of the width thereof, can have a calming or quieting surface which is angled through about 10° in the air flow direction so that it forms a constriction with the likewise angled end face of the oppositely disposed wall segment.

In a further embodiment a gas-dynamic lift of the combustion air over the wall segment is achieved by a ramp-shaped configuration of the side of the wall segment, which is towards the air afflux flow, with refractory material, so that imposed on the air flowing thereto, on the path over the ramp, there is initially a rise of between about 10° and 30° and at the end a rise of about 10°. The port floor can have substantially at its center a shaft which drops by about 10° in the direction of flow of the combustion air and which ends approximately at the wall segment.

In addition protection is claimed for a flame base shielding with a gas-dynamic, turbulence-reducing lift of combustion air over a wall-shaped air path-blocking installation in the form of a wall segment within a combustion air port which is characterised by the jetting introduction of recycled or afterburnt waste gas, preferably by means of a displacement lance according to the invention, into the spatial angle of the flame base screen, said angle being formed by means of the wall segment, on the side of the wall segment which is towards the air afflux flow, in particular from the port side wall, wherein the starting point of the jetting feed is close to the corner point of the spatial angle, which is formed by the wall segment, the port floor and the port side wall, on the side of the wall segment which is towards the combustion air afflux flow.

That waste gas jetting effect, after the rising masonry crown, forms the second gas-dynamic component of the flame base shielding according to the invention.

A preferred apparatus for turbulence-reducing lifting of the combustion air over the combustion air flow barrier is characterised in that a displacement lance is arranged on the air afflux flow side of the combustion air flow barrier at the foot thereof.

In an embodiment the displacement lance is in the form of a cylindrical lance which is substantially parallel to the port bottom and which at its one end has a feed means for a gas mixture or a combustible gas while the other end thereof is closed and is provided with at least one axial longitudinal slot for the gas discharge. The displacement lance and the gas discharge slot thereof can be positioned and adjusted by axial displacement and radial rotation with respect to the combustion air flow barrier.

In another embodiment the displacement lance is a multi-casing steel tube lance which is passed approximately perpendicularly through the port floor, wherein formed between two tubes of the lance is at least one coolant layer of circulating coolant, which has an outer gas feed casing which is shortened with respect to the lance and which is closed at the end and which at the closed end has a radially oriented and radially enlarging gas outlet slot at least where the surrounding tubular flow of the coolant layer is interrupted. It is substantially perpendicularly oriented through the port floor and arranged in such a way that the combustible gas jet issuing from the lance exits from the foot of the combustion air flow barrier where the edge of its end face, which is the front edge in the air flow direction, is exposed directly to the combustion air afflux flow, wherein the jet is directed near to the port floor and near to the combustion air flow barrier on to the port side wall to which the combustion air flow barrier is connected.

The introduction of fuel within the combustion air port is implemented in the flow shadow, remote from the air, of the wall segment, in particular in the spatial angle of the flame base screen, in such a way that the introduction of the fuel is positioned so close to the point of origin of the space which extends from the flame base screen and which is opened at three sides, that the peripheral line of the fuel jet approximately touches the lines of the wall segment and the port floor.

A preferred apparatus for the low-turbulence introduction of combustible gas for the suppression of intensive mixing of combustion air and combustible gas at the combustible gas intake within the combustion air port is a gas burner by which the gas jet is introduced in the form of a gas jet which in itself is of low turbulence into the combustion air port, by virtue of the fact that the outlet opening of the gas from the burner and/or burner nozzle block is in the form of a natural free jet, wherein the burner and/or burner nozzle block, as a gas outlet, is generally in the form of a diffuser with a flare angle of about 20°.

The outlet opening of the fuel into the spatial angle which is in the flow shadow is preferably so positioned and oriented that the peripheral line of the fuel jet at the entry into the combustion air port and/or the prolonged peripheral line of the outlet opening of the burner and/or burner nozzle block approximately touch the lines of the wall segment and the port floor but do not intersect same.

Gas burners which are suitable for producing a free jet are preferably employed. They can be pure free jet burners, or gas burners which are configuration-modifiable as free-jet or turbulence burners, by adjusting operations.

The last-mentioned gas burners are characterised in that the burner is provided with a cooling casing and arranged adjoining a cylindrical gas feed tube and forming the connection to the burner orifice is a long diffuser which has a free jet flare angle through 20°, wherein the burner has a minimum burner orifice diameter of about 50 mm which is thus very much larger than the conventional burner, wherein no nozzle block is arranged downstream of the burner but the direct burner gas outlet into the furnace chamber is formed by the burner orifice itself. The burner is preferably further characterised in that the gas feed to the long diffuser, over a length of about five diameters of the gas feed tube, does not include any fitments which are fixed or which can be introduced into that position by adjusting operations and which in particular would adversely affect the axis of the gas flow in the tube.

In the most preferred embodiment the shielding according to the invention is embodied by three elements. The first is the mechanical flow protection, which radially geometrically completely covers over the flame base, by the wall segment which in the axial extent of the flame, at the end of the wall segment, abruptly releases the entire fuel jet for air mixing thereinto. The second is the gas-dynamic increase in height of the wall segment and the resulting horizontal levelling and smoothing of the underside of the continuing air flow due to the masonry crown configuration which preferably rises at 10°. The third is the turbulence suppression and turbulence-reducing lift of the combustion air by ramp-shaped wall segment components or waste gas filling of the reduced-pressure space which is formed by the spatial angle at the air afflux side of the wall segment, wherein the combustion air is slidingly and gas-dynamically lifted over the segment wall by the mechanically forced flow or by means of expanding waste gas. In that situation that waste gas can be supplied cold from the exterior or can be formed in the port by combustion gas and air or waste gas.

The industrial use of the invention is advantageous in particular for those glass melting furnaces which have a lateral arrangement for introducing the fuel into the combustion air ports. Such furnaces certainly have advantages in terms of construction but in recent times they have been under threat because of their inferiority in terms of primary NOx-reduction as a solution with a promising future. The invention of the flame base shield is suitable for making up for that disadvantage and in addition giving force to the advantages of the smaller number of burners on that type of furnace as an advantage in NOx-reduction over the previously superior underbank-fired furnaces. The operators of such furnaces are in a position of being able to retain the type of furnace which is tried and tested for glass production, they are not compelled to adopt expensive system-extrinsic secondary measures or ‘3R’ in accordance with PL 922 48 52 and they can convert the type of furnace in on-going operation to best values in respect of NOx-reduction.

Positive side-effects in an appropriate implementation are as follows: energy saving, furnace chamber temperature reduction, increase in power and efficiency and an increase in the length of the furnace operating time. Arranging the apparatus according to the invention near the burner mouth of the combustion air port has an advantageous effect on the adjustability of the position of the flames.

Unlike threshold members or steps, it is possible without suffering from disadvantages to forego a relatively great path from the gas jetting intake to the burner mouth so that a variation in the burner angling has a marked influence on the position of the flame and firing management is thus technologically flexible.

The apparatus according to the invention has further numerous advantages over the state of the art.

Although the carburisation effect of the flame base shielding according to the invention is small in comparison with carburising steps, a comparatively higher degree of NOx-reduction is afforded in that the wall segment which is kept small from the design concept point of view, for shielding the flame base, can be designed in terms of its structural configuration without major side-effects in all dimensions of the appropriate size according to the requirements involved and in particular higher, so that the configuration of the flame base, which is in the form of a free jet, is completely covered in relation to a direct flow of air thereinto. The starting reaction and mixing with air is permitted completely only at the end of the shield and is not already partially permitted in the upper regions of the flame base. There however the fuel flow forms a sufficiently wide front which, by virtue of a large surface area, is capable of exchanging so much heat by means of radiant heat discharge to the surroundings that the adiabatic temperatures which are usually governed by an accumulation of heat, of conventional flame bases, are always avoided. In that respect the masonry crown which in accordance with the invention rises in the air flow direction forms an essential gas-dynamic contribution as the continuingly horizontally flat propagation of the air is advantageously promoted at the break-away edge thereof.

In contrast thereto, in the case of a carburisation step at the bank which is disposed parallel horizontally with respect to the port floor and which terminates with the break-away edge, propagation of the combustion air is thereafter promoted in a falling angle of about 10°, whereby the carburisation steps which are known (including the cascade steps) in regard to flow dynamics incorrectly only limitedly perform the intended function and in the course of flame development produce a severe thermal loading in a randomly dependent manner on the port floor which in itself is disposed after the threshold member.

In comparison with carburisation steps the flame base shielding according to the invention, at the base of the flame, with a low level of structural expenditure, provides that mixing of fuel with air is effectively reduced completely but not expensively, also involving the core of the flame, but at the same time only incompletely shielding same, and thereby the formation of a particularly hot or adiabatic temperature zone of the flame at the base thereof is suppressed. Detrimental turbulence effects in the rise in the air at the afflux side of the wall segment, which initially occurs due to the configuration in the form of a wall, which is necessary with the requirement for retro-fittability, are greatly reduced from the gas-dynamic point of view by the introduction of recycled, O₂-lean waste gas or combustible gas in combination with waste gas or air, into the upstream-disposed reduced-pressure region, so that the problem of this newly occurring, second flow dead zone at the shield is neutralised by waste gas which expands there. The amounts of fuel which are possibly used to start with for the purposes of waste gas production and lifting the air are in contrast small and are advantageously just so great that the waste gas entrained by the air flow is continuously replaced in the reduced-pressure space, to meet the requirements of the operating balance sheet, and this can be seen from a minimum of the NOx-emission. The problem of an accumulation of heat and adiabatic temperatures does not occur in this respect as the amount of fuel supplied burns predominantly or preferably completely externally, with waste gas admixing and, due to the locality, colder than usual, in the furnace. An additional NOx-source due to the combustible gas residues which are entrained into the furnace remains unnoticeably small.

The flame base shielding can be easily retrofitted as a primary measure, for example in comparison with carburisation steps, it is of a structural size which is functionally optimised as a compromise, and it can be optimised both in terms of flow technology and also gas-dynamically.

An advantageous side-effect of the third functional element is that waste gas is introduced from the space in front of the wall segment due to the suction action of the air flowing thereover, into the lower layers of the combustion air, before the air passes into the reaction space after the screen. The starting reaction is thus additionally reduced in terms of the substances involved, in the upper region of the flame or more precisely at the interface between the fuel and the air. An increased introduction of fuels, for the purpose of producing a strong waste gas separating layer, as is known from cascade firing arrangements, is non-productive at the flame base screen as the known disadvantage of forming a new NOx-source at the pre-firing area by virtue of waste gas filling when there is an excess of fuel, can also become disadvantageous. Desirably the waste gas filling of the afflux flow region at the flame base screen only remedies a flow-technological defect in the geometrical protection, which in itself is already complete, for the whole of the flame base which occurs in the upstream-disposed, structurally governed, turbulence-triggering afflux flow in relation to the wall segment, insofar as it continuously fills up the reduced-pressure zone there and reduces the gas-dynamic influence thereof on the air flow.

The advantageous design configuration of the displacement lance with axial gas outlet slots, even if it is operated with a small amount of combustible gas, always ensures relatively large and thus cold flame surfaces so that little NOx is formed. The low-impulse feed of waste gas is effected through the radial gas openings directly into the reduced-pressure zone in the foot region of the wall segment in geometrically adapted form.

The short structural length of the wall segments which are usually arranged symmetrically in opposite relationship leaves a large portion at the port floor free from fitments which impede the air flow. In that way that portion which in the case of threshold members or steps is characterised in particular by carbon deposits is kept free from carbon deposits by an intensified combustion air flow. There is thus no quality risk to the molten material, which goes beyond that of conventional ports which do not have any flow-constricting fitments.

In an advantageous configuration the fuel is introduced as a jet by means of a free jet burner at the flame base screen and facing away from the three space-forming walls at least in each case at about 10°, wherein the degree to which it faces away is greatest from the port wall. In that case flow-technologically random firing phenomena at the flame base are particularly effectively avoided. It is advantageous that the wall segment does not require any continuous expenditure for operation and the flame base screen is already properly operational with this simple structure.

Further advantages are that the apparatus can be retrofitted at low cost to existing installations and that after it has been brought into operation even for furnaces with intensive cross-mixing between fuel and combustion air further NOx-primary measures can be effectively applied. For example then besides the free jet burners which can preferably be used, other burners with a small gas impulse also deploy their NOx-reducing action. The nozzle block and the burner are better thermally protected by the flame base screen.

The invention will now be described in greater detail by means of embodiments with reference to the accompanying drawings in which:

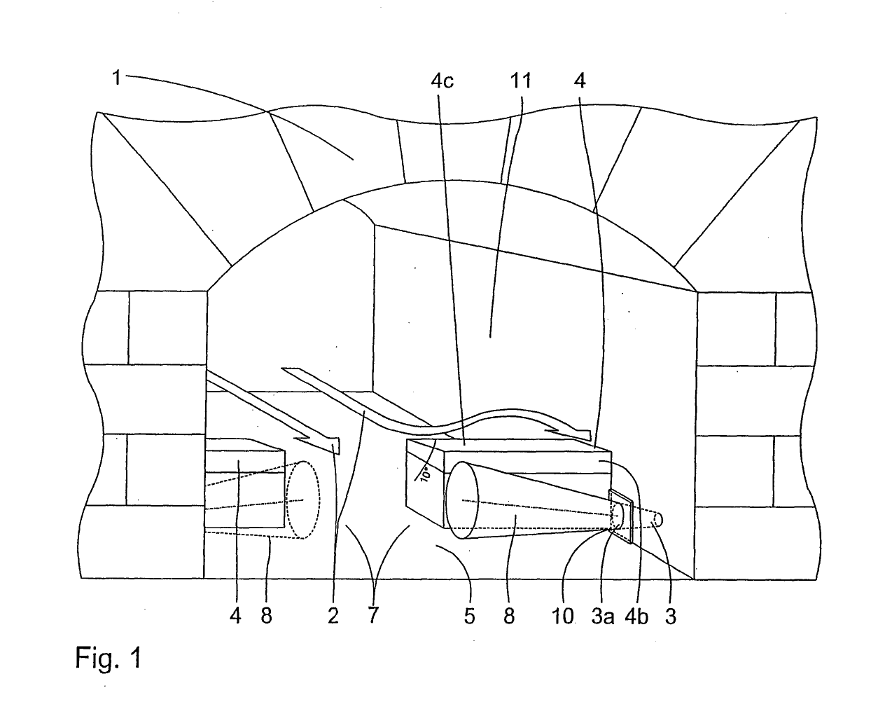

FIG. 1 is a perspective view of a preferred embodiment of the mechanical flame base shielding according to the invention,

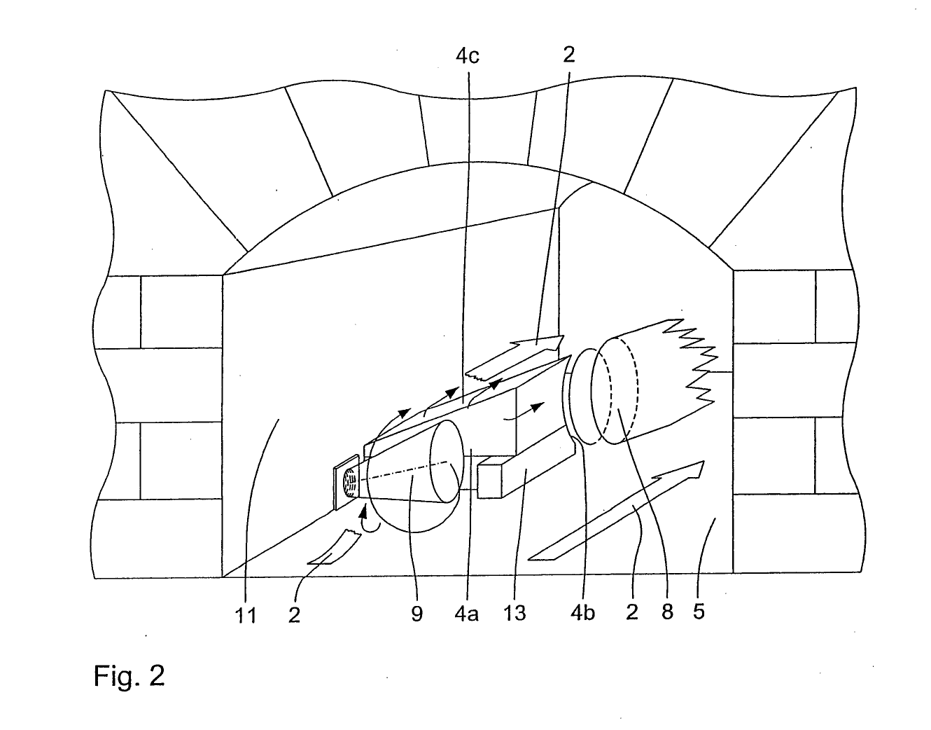

FIG. 2 is a perspective view of another preferred embodiment of the complete flame base shielding according to the invention,

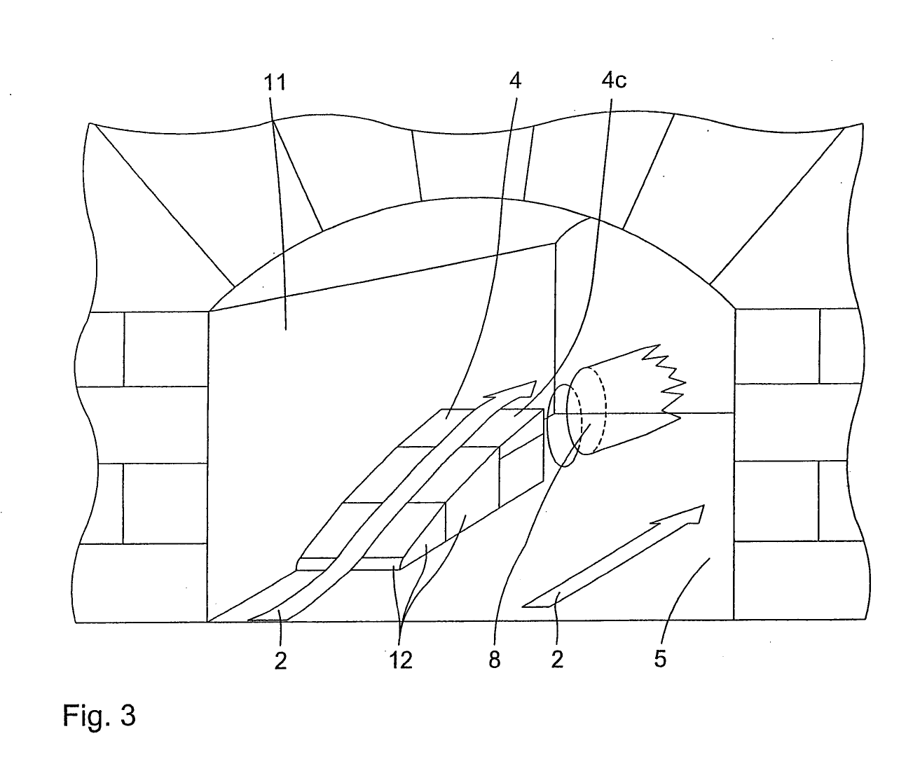

FIG. 3 shows the mechanical flame base shielding with combustion air lift with turbulence-reducing ancillary block,

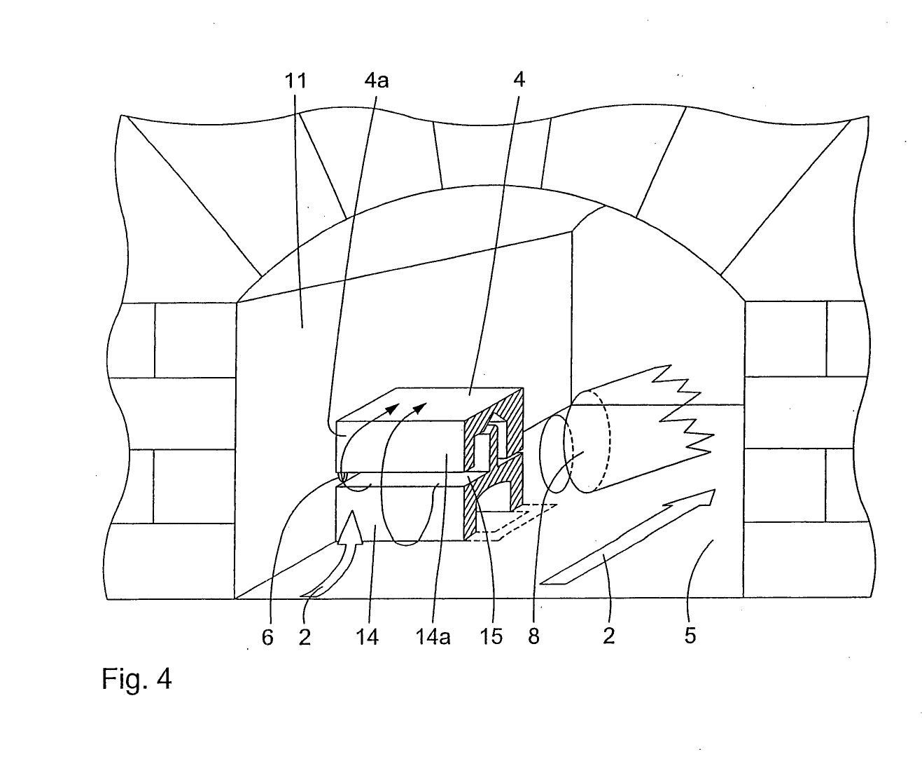

FIG. 4 shows the introduction of waste gas into a wall segment according to the invention,

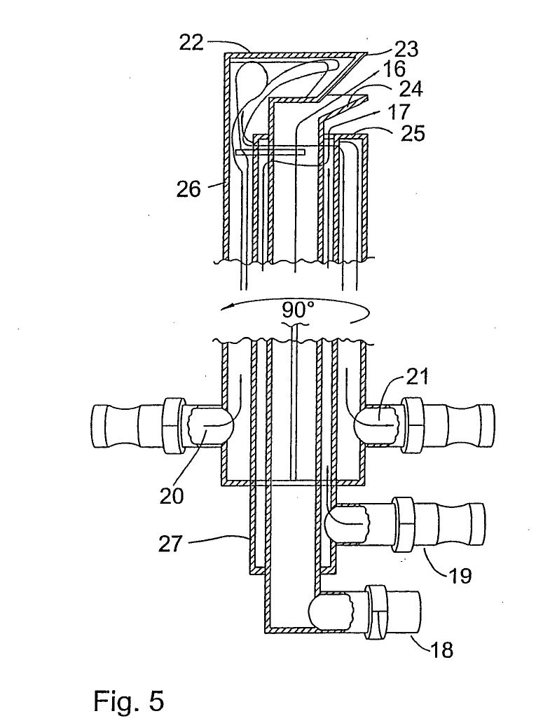

FIG. 5 shows an embodiment of a displacement lance according to the invention with radially oriented fuel and air outlets,

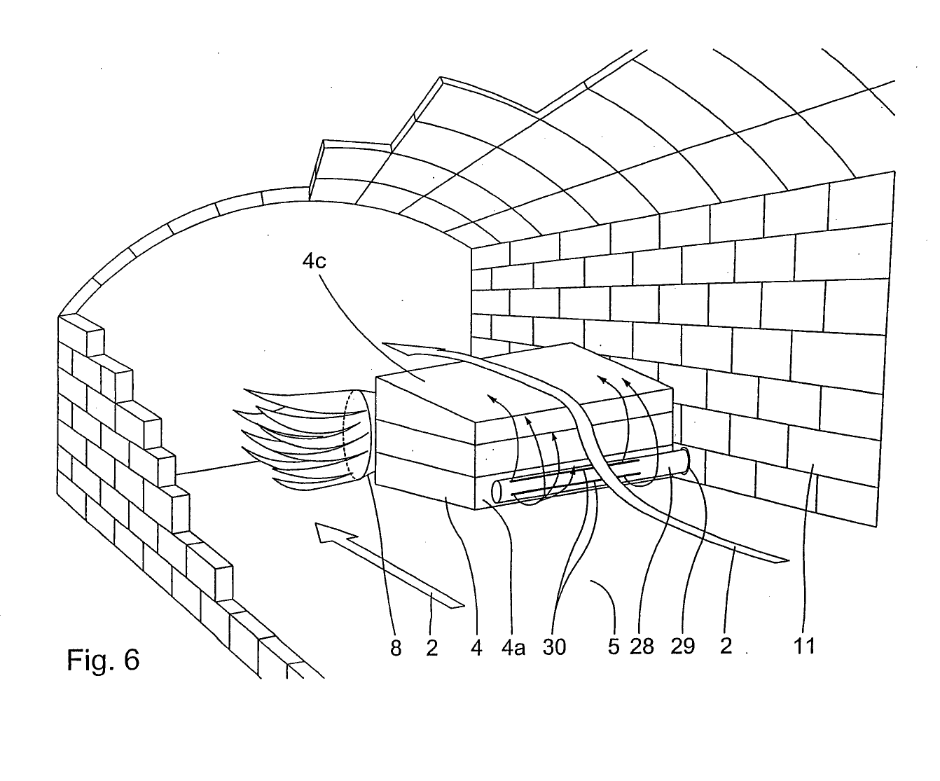

FIG. 6 shows another embodiment of a displacement lance with a radial gas outlet and the arrangement thereof on the wall segment, and

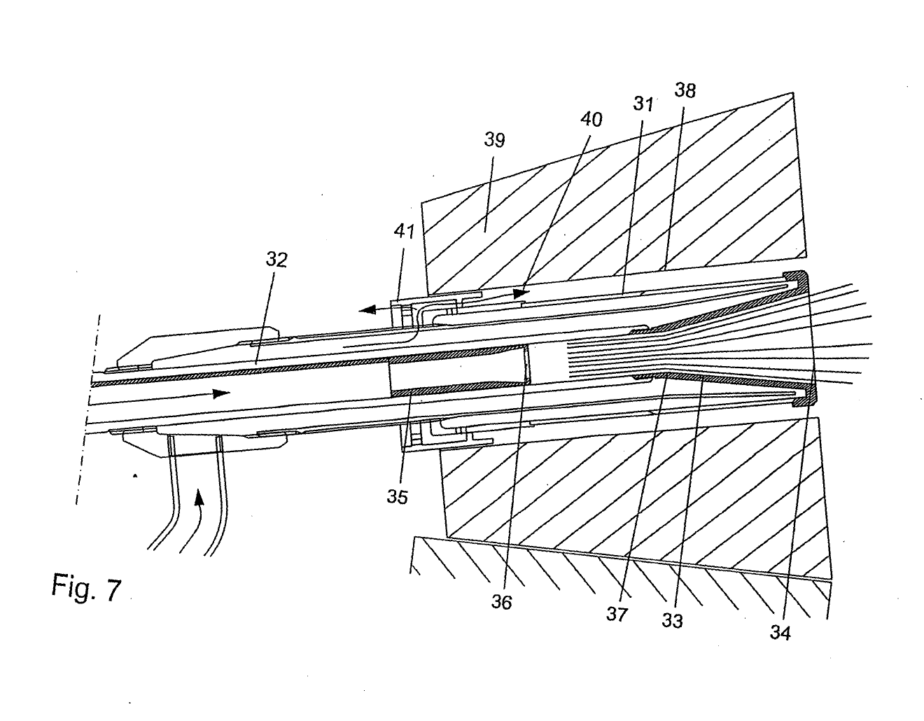

FIG. 7 shows an advantageous air-cooled free jet gas burner.

FIG. 1 is a diagrammatic perspective view of a combustion air port 1 of a float glass furnace with a lateral arrangement of the burners 3. The combustion air port 1 is equipped in on-going operation with a flame base shielding according to the invention. For that purpose disposed transversely with respect to the direction of the air flow 2 and, in the air flow direction, upstream of the burner nozzle blocks or the burner orifice 3a, stackable blocks are disposed in the form of a wall segment 4 in layered arrangement on the port floor 5 adjoining the port side wall 11, the blocks having positively locking profiling at the inner contact surfaces. The burner 3 is arranged downstream of the wall segment 4 in the combustion air flow direction. The prolonged axis of the burner nozzle blocks or burner orifice 3a is turned away from the wall line 4b of the wall segment 4, being the downstream wall line in the flow direction, in such a way that the flat angling is about 10°, measured horizontally in the direction of the combustion air flow 2, with respect to the wall line 4b of the wall segment 4. The same axis has a vertical rise of 10°, measured with respect to the plane of the port floor 5.

The type of burner used can be what are referred to as free jet gas burners, as are disclosed in DE 195 20 650, or gas burners whose orifice, instead of the burner nozzle block which is conventionally used adjoining the burners, itself forms the mouth orifice. A burner of that kind is shown in FIG. 7 and is described in greater detail hereinafter.

In the latter case the diameter of the mouth orifice 3a for the fuel is thus the opening of the burner. The dimension thereof is in the illustrated example 95 mm, the width of the port being 1.5 m. The dimensions of the wall segment 4 of the flame base shielding according to the invention are in the illustrated embodiment as follows: length 500 mm, width 250 mm and height 300 mm. The height is accordingly defined as the sum of the diameter of the burner orifice 3a and ⅓rd of the length of the wall segment 4, in which respect in the present case the elevated position of the burner orifice 3a was also to be taken into consideration in calculating the height of the wall segment 4, that is to say, in order to compensate for the structurally governed error in the position of the burner orifice 3a in relation to the point of origin 10 of the wall segment 4, as in the illustrated embodiment the fuel jet 8, deviating from the preferred positioning according to the invention, does not touch the port floor 5.

In the illustrated example the lower edge of the burner intake orifice is 40 mm above the port floor 5 and the lower directrix of the continuing jet which is assumed to be a free jet is in parallel relationship with the port floor 5, lifted by that dimension above same. The region at the upper directrix of the fuel jet 8 would otherwise be exposed to premature mixing of air thereinto. The wall segment 4 was therefore desirably made 40 mm higher.

The wall segment 4 over its entire width has a masonry crown 4c which rises through 10° with respect to the port floor 5 in the direction of the air flow 2.

The short structural length of the wall segments 4 which are arranged in symmetrically opposite relationship leaves on the port floor 5 a large portion which is free from air flow-impeding fitments. In that way that portion is kept free from carbon deposits by an intensified combustion air flow. There is thus no quality risk in regard to the molten material, which goes beyond that of conventional ports which do not have any flow-constricting fitments therein. At the distal end of the wall segment 4 the entire fuel jet is abruptly released at the fuel passage 7 for the combustion air to be mixed therein.

Two methods have proven themselves to be practicable for installation of the wall segment 4 according to the invention. In the former method the port side wall 11 is opened laterally beside the burner nozzle block or the burner orifice 3a in order for the components to be introduced into the port 1 by being pushed in from the side and by stacking the layers thereof. In the second method the port floor 5 is sawn open from below. The floor portion which has been cut out is then lowered with a hoist platform, cleared away and discarded. A fresh floor segment is built up with the wall segment 4 of the flame base screen on the hoist platform and by means thereof lifted into the port 1 again to a position slightly below the level of the old port floor 5, or is arranged sunk into the new port floor segment in order thereby securely to prevent the wall segment from slipping on the port floor 5. The procedure which involves sawing open the port floor is advantageous in terms of labor costs and working difficulties.

As a result of the described embodiment a reduction in the NOx-formation of about 50% is achieved. At the same time further advantageous side-effects occur in terms of furnace operation. In particular the fuel consumption is reduced, the temperature of the furnace roof is lowered and thus a lower degree of corrosion of the refractory material is attained. An increase in the melting output of the furnace is also significant.

FIG. 2 shows a further advantageous embodiment of the flame base screen and in comparison with FIG. 1 additionally provided with the second gas-dynamic component of the flame base screen in the form of a turbulence-reducing combustion air lift by virtue of the introduction of gas upstream of the wall segment 4. To simplify the drawing, only one wall segment is illustrated, the wall segment arranged at the opposite side wall of the port has been omitted. In addition, this embodiment of the wall segment according to the invention uses special components which, as a departure from conventional block formats, form an additional rise at the masonry crown 4c of the wall segment 4 from the port side wall 11 to the distal end of the wall segment 4, which is towards the port center, through about 20°, and which thus better adapt the external geometry of the wall segment 4 to the gas jet form 8 of a natural free jet and which, with further improved shielding of the flame base, by virtue of the smaller structural size thereof, at the same time have a slight barrier effect in the waste gas period and slight air distribution side-effects in relation to cross-flame furnaces. The NOx-effective greatest height of the wall segment as set forth in claim 7 is maintained.

In the present case, proposed as an apparatus involving burner technology for the introduction of waste gas is a per se known burner for flameless oxidation which hitherto could not be used for heating glass melting furnaces in its known design configurations. The limitation in respect of use thereof is due to the excessively low waste gas temperature and complete combustion in the burner, which here however is advantageous by virtue of the fact that now only waste gas is introduced thereby into the furnace and the effect of an additional NOx-source, being known from situations involving additional flames, no longer occurs. The burner is inserted from the port side wall 11 and its jet 9 is passed inclinedly upwardly in the direction of the port center along the wall segment 4 on the side of the upstream wall surface 4a. The required amounts of waste gas are of the order of magnitude of between one and a few percent of the total amount of waste gas. The apparatus is supplemented by action on the part of the man skilled in the art by an ancillary block 13 at the lower layer of the wall segment 4, which is intended to prevent waste gas escaping deep and ineffectually and which diverts it on to the more effective upper flow paths. In addition, in terms of action of a man skilled in the art, the combustion jet side at the rear wall surface 4b of the wall segment 4 is of a concave configuration.

FIG. 3 shows a wall segment 4 in which the combustion air lifting effect, instead of being achieved by means of the gas-dynamic component, is implemented by means of a mechanical device, for example turbulence-reducing upstream-disposed ancillary blocks 12 which in the flow direction of the air are arranged rising from the port floor 5 steadily and steplessly through about 10° to the crown 4c of the wall segment 4. This solution has the disadvantages however in comparison with the gas-dynamic component that an advantageous design concept or a simple technology has not yet been found for retrofitting of the ports in on-going operation and therefore it can only be used upon re-construction or cold repair of the furnace and is scarcely available for a simple repair.

FIG. 4 shows the introduction of waste gas for the gas-dynamic combustion air lifting action according to the invention, into the wall segment 4. The wall segment 4 is formed from suitably shaped wall segment building blocks 14, wherein the upper wall segment block 14 is modified in such a way that its support leg 14a is shortened at the side of the upstream wall surface 4a and does not rest in positively locking relationship on the lower wall segment block 14 and thus forms a gas outlet slot 15 for the waste gas which is introduced through a waste gas feed 6 through the wall. It is possible in FIG. 4 to see the internal structure due to the section of the wall segment 4, but the refractory layer on the wall segment 4, which closes it at the end, is not shown. The introduction of waste gas into the upper wall segment block 14 of the wall segment 4 is effected from the port side wall 11 by means of a per se known configuration comprising a waste gas feed 6 and a per se known burner for flameless oxidation (not shown) with a ceramic burner tube. The drawing does not show an alternative thereto, in which a compact wall segment is provided with a blind bore having a lateral slot in a similar position to that shown in FIG. 4. Combustible gas, waste gas or a combustible gas mixture is jetted into the blind hole in the firing period.

FIG. 5 shows the possible and advantageous configuration of a displacement lance according to the invention with radially oriented fuel and air discharge in a sectional view, wherein the cold end 27 in the Figure is shown as being turned in the clockwise direction through 90° relative to the hot end which is essential for implementation of the process and for the apparatus. A cooling water feed 20 feeds an external water circuit which, near the end plate 22 at the hot end 26, has a semicylindrical outer interruption in the surrounding tubing configuration of the water cooling casing. That interruption provides a radial combustible gas outlet 16 and a radial air outlet 17. In a plan view (not shown) those outlets would be approximately semicircular. The cooling water circuit is separated from the combustible gas outlet 16 by the casing of a frustoconical segment 23, wherein that at the same time imposes on the upper flank of the gas jet an outward deflection in the radial direction through about 50° from the axial afflux flow. Jointly with a diffuser segment 24 which in turn has a radial deflection of about 70°, the gas jet at the combustible gas outlet is forced to adopt an outlet angle which has a rise of 30° relative to the radial plane. The gap-shaped opening itself has a flare angle of 20° and thus, even if only partially, in a sectional plane, satisfies the criteria for the formation of a natural free jet. The radial air outlet 17 is likewise formed in accordance with the above-mentioned partial free jet criterion upwardly by the underside of the diffuser segment 24 and downwardly by a disk segment 25. As a result extending in a layer under the free gas jet is a free air jet whose lower surface extends parallel to the radial plane. This is therefore essential for the process because, in the situation of installation the port floor also extends parallel to the radial plane and thus the air is not directed towards the port floor. The flame which is formed is calmed and steadied as best as possible by both free jets and at the same time is as close as possible to the port floor without being directed towards it. The cold end 27 has as the media connections the combustible gas connection 18, the air connection 19, the cooling water feed 20 and the cooling water return 21. The cooling water feed and return are in the configuration of a half-shell portion for reasons of avoiding a high level of structural complication and expenditure, which is a disadvantage in alternatively multi-casing design configurations. The lance is preferably operated with similar gas pressures in relation to combustible gas and atomiser air. It is only for reasons of clearly illustrating the operating principle involved that the air outlet in the example is shown as being of similar size in relation to the gas outlet. It is usual for implementing the process that the passage-determining smallest slot dimension for the air is a multiple greater than that for the combustible gas.

FIG. 6 shows a simple clear illustration of a displacement lance 28 with axial slots 30 in a horizontal situation of installation in the spatial angle of the foot of a wall segment 4 on the side 4a thereof which is exposed to the afflux flow of the combustion air 2.

In the illustrated example the displacement lance 28 has two axial slots 30 which are directed towards the afflux flow of combustion air in such a way that the waste gas issuing from the slots 30, by virtue of the entry impulse and the thermal gas expansion effect, forms a gas-dynamic waste gas spoiler which lifts the combustion air with a turbulence-reducing action over the flow obstacle in the form of the wall segment 4. Setting of the lance position is simple for the reason that the lance is arranged displaceably and rotatably through the wall bore 29 on the cold side of the port side wall 11 (not shown).

FIG. 7 shows a possible embodiment of a burner for producing a free combustible gas jet, as is preferably used. The technology of the combustion process also has a great influence on product quality, energy economy, operating life expectancy and the production capacity of industrial furnaces. That influence is particularly strong however on the formation of NOx. What has proven to be particularly effective in relation to gas burners for glass melting furnaces is what is known as a free jet gas burner in which there is a very high degree of reduction in nitrogen oxide formation.

The burner used according to the invention is preferably a configuration-modifiable burner which does not require a nozzle block but which is of a closed and entirely metallic and cooled configuration, wherein a long diffuser externally forms the gas flow chamber and arranged therein is an axially displaceable cylindrical gas feed tube and the cooling air can be fed with a controllable cooling air flow deflection to the burner orifice in the form of an enclosing combustion primary air flow. In that way the flame can be substantially adjusted in the range of the characteristic of conventional burner constructions. In the case of quality shortfalls of obscure origin it is possible to have recourse to early experience with quality assurance with known means and settings. For that purpose it is then only necessary to adjust the burner with positioning of the central nozzle in the area around the diffuser root. That therefore forms a heavily turbulent flame which has long been known and which selectively can still be further modified by means of primary air around a sharp starting reaction. It is thus possible to make use of old notes relating to quality-assuring modes of operating a furnace. The effective mode of operation of the burner in the free-jet mode of operation can thus be adjusted stepwise, starting from the conventional combustion jet.

The burner is described hereinafter in its configuration in the form of a free jet burner, as is preferably used in combination with the wall segments according to the invention and the gas-dynamic combustion air lifting effect.

For that purpose the cylindrical central nozzle tube 35 is completely retracted from the long diffuser 33 and positioned in the gas feed tube 32 with the nozzle orifice 36 of the central nozzle tube 35 spaced from the base 37 of the long diffuser 33 by five times the diameter of the cylindrical gas feed tube 32. The cooling air flow deflection means 41 blocks the path for the combustion primary air flow 40 between the cooling casing 31 and the burner mounting block 39 into the free space of the burner insertion bore 38. A low-turbulence free gas jet issues at the burner orifice 34. The weakened mixing thereinto of air from the ambient atmosphere, the subsequent carburisation of the combustible gas with high proportions of carbon particles and ignition of the flame only in a region of large flame surface area, that is to say with good heat radiation conditions, are the causes of the low level of NOx-emission of the burner at that setting, at which the usual high or indeed adiabatic flame temperatures are reliably avoided.

### List of References Used

1 combustion air port

2 combustion air

3 burner

3a burner nozzle block/burner orifice

4 wall segment

4a front wall surface

4b rear wall surface

4c masonry crown

5 port floor

6 waste gas feed

7 combustion air passage

8 fuel jet

9 waste gas jet

10 point of origin

11 port side wall

12 turbulence-reducing ancillary block

13 ancillary block

14 wall segment building block

14a support leg

15 gas outlet slot

16 radial combustible gas outlet

17 radial air outlet

18 combustible gas connection

19 air connection

20 cooling water feed

21 cooling water return

22 end plate

23 surface of the frustoconical segment

24 diffuser segment

25 disk segment

26 hot end

27 cold end

28 displacement lance with axial slots

29 wall bore

30 axial slot

31 cooling casing

32 gas feed tube

33 long diffuser

34 orifice of the burner

35 central nozzle tube

36 nozzle orifice of the central nozzle tube

37 base of the long diffuser

38 burner insertion bore

39 burner receiving block

40 combustion primary air flow

41 cooling air flow deflection

1. A process for nitrogen oxide reduction in combustion air ports of glass melting furnaces, characterised in that a flow shadow is formed for affording protection from a combustion air through-flow for the direct region of the mouth opening of the fuel jet within the combustion air port by means of a mechanical combustion air flow barrier which radially geometrically completely covers over that region, which flow shadow is extended in the air flow direction subsequently to the combustion air flow barrier in the form of a flow shadow which is substantially parallel to the port floor, wherein the entire fuel jet is abruptly released for mixing in the air at the distal end of the combustion air flow barrier at the combustion air passage.

2. A process for nitrogen oxide reduction in combustion air ports of glass melting furnaces, characterised in that at least one gas jet is injected into the turbulence space upstream of flow obstacles in such a way that the reduced-pressure space there is actively and dynamically filled with gas in such a large amount that including the thermal gas expansion in that region there is predominantly substantially a small over-pressure.

3. A process for nitrogen oxide reduction in combustion air ports of glass melting furnaces, characterised by the combination of the processes as set forth in claim 1 and claim 2.

4. A process as set forth in claim 2 or claim 3 characterised in that the gas jet is preferably introduced in the form of a gas layer into the foot zone, which is exposed to the air afflux flow, of the flow barrier/the flow obstacle, in an amount which is between 1 and 5% of the fuel flow of the combustion air port in question.

5. A process as set forth in one of claims 1 through 4 characterised in that the combustible gas is injected in the form of a pre-shaped natural jet into the spatial angle which is arranged downstream of the combustion air flow barrier and which is closed at three sides.

6. An apparatus for forming a flow shadow for affording protection from combustion air through-flow for the direct region of the fuel jet within a combustion air port for carrying out the process as set forth in claim 1, claim 3, claim 4 or claim 5 characterised by an air path-blocking wall segment (4) which forms a spatial angle closed at three sides, with the port floor (5) and a port side wall (11).

7. Apparatus as set forth in claim 6 characterised in that the wall segment (4) is of a length which is markedly shorter than half the width of the port floor (5), the wall segment (4) is arranged substantially perpendicularly to the port side wall (11) facing into the combustion air port (1), and its greatest height in relation to the lower directrix of the idealised gas free jet (8) is approximately equal to or greater than the sum of the diameter of the combustion gas intake (3a) and ⅓rd of the length of the wall segment (4).

8. Apparatus as set forth in claim 6 or claim 7 characterised in that the crown (4c) of the wall segment (4) at least over a part of its length and at least over the major part of its width is provided with an air guide surface which rises shallowly in the flow direction of the combustion air (2) and which has a sharp flow break-away edge.

9. Apparatus as set forth in claim 8 characterised in that the shallow rise is at an angle of about 10° with respect to the subsequent port floor.

10. Apparatus as set forth in one or more of claims 6 through 9 characterised in that the apex of the crown (4c) of the wall segment (4), in the afflux flow direction of the combustion air (2), simulates a vertically flat projection of a free gas jet.

11. Apparatus as set forth in claim 10 characterised in that the apex of the crown (4c) from the port side wall (11) to its distal end has a continuous or stepped rise of about 20°.

12. Apparatus as set forth in one of claims 6 through 11 characterised in that the perpendicular end face of the wall segment (4), which faces towards the port center, at least over the major part of the width thereof, has a calming surface which is angled through about 10° in the air afflux direction so that with the likewise angled end face of an oppositely disposed wall segment (4) it forms a constriction.

13. Apparatus as set forth in one or more of claims 6 through 12 characterised in that the side of the combustion air flow barrier, which is towards the air afflux flow, is provided in a ramp configuration with refractory material (12) in such a way that on the way over the ramp a rise of between about 10° and 30° is initially imposed on the afflux flow of air and at the end a rise of about 10° is imposed thereon.

14. Apparatus as set forth in claim 13 characterised in that the ramp is of a horizontally flat configuration and that on the length of the ramp and subsequently the port floor falls away at about 10° relative to the horizontal plane in the air flow direction.

15. Apparatus for jetting in a gas jet for carrying out the process as set forth in claim 2, claim 3 or claim 4 characterised in that arranged on the air afflux flow side of the combustion air flow barrier at the foot thereof is a displacement lance for feeding at least one gas jet.

16. Apparatus as set forth in claim 15 characterised in that the displacement lance is in the form of a cylindrical lance which is disposed in approximately parallel relationship with the port floor and which at its one end has at least one feed for a gas mixture or a combustible gas and the other end of which is closed and which is provided with at least one axial longitudinal slot for the gas discharge.

17. Apparatus as set forth in claim 16 characterised in that the displacement lance and the gas discharge slots thereof is positionable and adjustable by axial displacement and radial rotation in relation to the combustion air flow barrier, by virtue of the fact that it projects substantially horizontally through a bore in the port side wall into the port and outside the port the shaft of the displacement lance is accommodated in at least one tube clamp.

18. Apparatus as set forth in claim 15 characterised in that the displacement lance is a multi-casing steel tube lance which is passed substantially perpendicularly through the port floor, wherein formed between two tubes of the lance is at least one coolant layer comprising circulating coolant, which has an outer gas feed casing which is shortened with respect to the lance and which is closed at the end and which at the closed end has a radially oriented and radially expanding gas outlet slot at least where the tubular enclosure formed by the coolant layer is interrupted.

19. Apparatus as set forth in claim 18 characterised in that the displacement lance is substantially perpendicularly oriented through the port floor and arranged in such a way that the combustible gas jet issuing from the lance preferably issues from the foot of the combustion air flow barrier where the edge of the end face thereof, which is the upstream edge in the air flow direction, is directly exposed to the combustion air afflux flow, wherein the jet is directed near to the port floor and near to the combustion air flow barrier on to the port side wall to which the combustion air flow barrier is connected.

20. Apparatus for the low-turbulence introduction of combustible gas into combustion air ports of tank furnaces for suppressing intensive mixing of combustion air and combustible gas at the combustible gas intake within the combustion air port for carrying out the process as set forth in claim 5 characterised in that the gas jet of the combustible gas-introducing burner is introduced into a combustion air port in the form of a gas jet which in itself involves low turbulence, into the combustion air port, by the discharge opening of the gas from the burner and/or burner nozzle block being in the form of a natural free jet, wherein the burner and/or the burner nozzle jet as the gas discharge are generally in the form of a diffuser with a flare angle of about 20° and the length of the diffuser is greater than its smallest diameter.

21. Apparatus as set forth in claim 20 characterised in that the discharge opening of the fuel into the spatial angle which is disposed in the flow shadow is so positioned and oriented that the peripheral line of the fuel jet at the entry into the combustion air port and/or the prolonged peripheral line of the discharge opening of the burner and/or burner nozzle block approximately touch the lines of the wall segment and the port floor but do not overlap same.
